(19) United States
(12) Patent Application Publication
(10) Pub. No.: US 2026/0145166 A1
(43) Pub. Date: May 28, 2026

(54) MIXED-ANION SORBENT FOR DUAL-FUNCTIONAL MOISTURE-SWING DIRECT AIR CAPTURE OF CARBON DIOXIDE AND AMBIENT WATER HARVESTING

(71) Applicant: The Trustees of Princeton University, Princeton, NJ (US)

(72) Inventors: Kelsey Hatzell, Princeton, NJ (US); Yaquang Zhu, Princeton, NJ (US); Austin Booth, Princeton, NJ (US)

(73) Assignee: The Trustees of Princeton University, Princeton, NJ (US)

(21) Appl. No.: 19/392,979

(22) Filed: Nov. 18, 2025

Related U.S. Application Data
(60) Provisional application No. 63/723,800, filed on Nov. 22, 2024.

(51) Int. Cl. B01J 41/12; B01D 53/62; B01D 53/82; B01D 53/96; B01J 41/05; B01J 47/014; B01J 49/57

(52) U.S. Cl. CPC B01J 41/12; B01D 53/62; B01D 53/82; B01D 53/96; B01J 41/05; B01J 47/014; B01J 49/57; B01D 2253/206; B01D 2253/306; B01D 2253/308; B01D 2257/504; B01D 2258/06

(57) ABSTRACT

The present disclosure provides a moisture-swing sorbent composition comprising an ion exchange resin loaded with borate ions. The composition captures carbon dioxide from ambient air at low humidity and releases it when exposed to high humidity environments. The ion exchange resin contains quaternary ammonium functional groups that serve as cation sites for charge neutrality with anionic species. The ions may consist of carbonate and borate ions, providing synergistic effects that enhance both capacity and rate of carbon dioxide capture compared to single-anion systems. The composition demonstrates dual functionality through simultaneous carbon dioxide capture and atmospheric water harvesting capabilities. The sorbent achieves moisture-swing carbon dioxide capacities while maintaining reversible operation through humidity-controlled regeneration cycles without requiring high temperature or pressure swing regeneration methods.

### CROSS-REFERENCE TO RELATED APPLICATIONS

This application claims priority to U.S. Application No. 63/723,800, titled “Mixed-Anion Sorbent for Dual-Functional Moisture-Swing Direct Air Capture of Carbon Dioxide and Ambient Water Harvesting”, filed Nov. 22, 2024, which is hereby incorporated by reference in its entirety.

### FIELD OF INVENTION

The present disclosure relates to carbon dioxide capture technologies, and more particularly to a mixed-anion sorbent composition for dual-functional moisture-swing direct air capture of carbon dioxide and ambient water harvesting.

### BACKGROUND

Direct air capture technologies represent an emerging approach to address rising atmospheric carbon dioxide concentrations by extracting CO₂ directly from ambient air. Unlike traditional carbon capture systems that target concentrated emission sources, direct air capture systems operate on dilute atmospheric CO₂ concentrations of approximately 400-420 parts per million. This low concentration presents challenges for efficient separation and capture processes.

Conventional direct air capture systems typically rely on temperature swing or pressure swing regeneration methods to release captured CO₂ from sorbent materials. These approaches often require substantial energy inputs, with temperature swing systems operating at temperatures ranging from 300° C. to 900° C. for sorbent regeneration. The high energy requirements associated with these regeneration processes contribute to the overall cost and complexity of direct air capture operations.

Moisture-swing direct air capture represents an alternative approach that utilizes humidity changes rather than temperature or pressure variations for sorbent regeneration. In moisture-swing systems, sorbent materials capture CO₂ under low humidity conditions and release the captured CO₂ when exposed to high humidity environments. This approach can potentially reduce the energy intensity of the capture and regeneration cycle compared to conventional methods.

Ion exchange resins have been explored as sorbent materials for moisture-swing applications. These materials typically contain quaternary ammonium groups and various counterions that facilitate the moisture-dependent capture and release mechanisms. The performance of such systems depends on factors including the chemical properties of the counterions, the structural characteristics of the resin matrix, and the interactions between water molecules and the active sites within the material.

Water management presents additional considerations for direct air capture systems. Large-scale implementation of moisture-swing technologies may require substantial water resources for operation, which could present both technical and environmental challenges. Approaches that can address water requirements while maintaining capture performance may offer advantages for practical deployment of direct air capture technologies.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a moisture-swing sorbent composition may be provided. The moisture-swing sorbent composition may include an ion exchange resin loaded with a plurality of ions, where the plurality of ions may include a plurality of borate ions.

According to other aspects of the present disclosure, the moisture-swing sorbent composition may include one or more of the following features. The plurality of ions may consist of a plurality of carbonate ions and a plurality of borate ions. The moisture-swing sorbent composition (and particularly the ion exchange resin) may have a surface area of less than 200 m²/g. The moisture-swing sorbent composition (and particularly the ion exchange resin) may have a surface area of 200-300 m²/g. The moisture-swing sorbent composition (and particularly the ion exchange resin) may have a surface area of more than 300 m²/g. The moisture-swing sorbent component may have a plurality of small pores having an average pore radius of less than 10 nm, and a plurality of large pores having an average pore radius of at least 25 nm. The average pore radius of the plurality of small pores may be 2 nm-4 nm, and the average pore radius of the plurality of large pores may be 35 nm-135 nm.

According to another aspect of the present disclosure, a moisture-swing sorbent system may be provided. The moisture-swing sorbent system may include a moisture-swing sorbent composition having an ion exchange resin loaded with a plurality of ions including a plurality of borate ions. The moisture-swing sorbent system may include a housing having an inlet and outlet, where the housing may surround the moisture-swing sorbent composition, and where the inlet may be configured to receive a gas and direct the gas over or through the moisture-swing sorbent composition.

According to other aspects of the present disclosure, the moisture-swing sorbent system may include one or more of the following features. The moisture-swing sorbent system may further include a processor configured to control the moisture-swing sorbent system such that a wet gas may be passed over or through the moisture-swing sorbent composition when the moisture-swing sorbent composition may be dry, and a dry gas may be passed over or through the moisture-swing sorbent composition when the moisture-swing sorbent composition may be wet. The moisture-swing sorbent system may further include a humidity control system, where the humidity control system may be configured to prevent water condensation within the housing when the dew point in the gas may be higher than room temperature. The gas may be air. The gas may be a gas other than air.

According to another aspect of the present disclosure, a method of manufacturing a moisture-swing sorbent composition may be provided. The method may include mixing boric acid and sodium hydroxide in water to generate a basic solution of borate ions. The method may include adding sodium carbonate to the basic solution of borate ions to create a carbonate-borate mixture. The method may include mixing the carbonate-borate mixture with ion exchange resin particles to form intermediate particles in solution. The method may include forming the moisture-swing sorbent composition by filtering out the intermediate particles, washing the intermediate particles, and then drying the intermediate particles.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIGS. 1A and 1B are illustrations of a moisture-swing CO₂ capture mechanism as disclosed herein, including a schematic of the CO₂ capture process, including the hydrolysis of anions (1A, Step 1) and CO₂ reaction with hydroxide (1A, Step 2), and the absorbent regeneration and CO₂ release process under high humidity (1B), where the identity of the anion species determines whether its protonated form can successfully react with HCO₃⁻ to release CO₂ (Step 3).

FIG. 2 depicts a graph showing CO₂ capture behavior of a CO₃²⁻-resin in air containing 417 ppm of CO₂ at 15% humidity.

FIG. 3 depicts a graph showing CO₂ capture and release behavior of the CO₃²⁻-resin at 20° C. by the moisture-swing process over five cycles.

FIG. 4 depicts a bar graph of the CO₂ capture absorption capacity and moisture-swing CO₂ capacity for resins with different anions. Error bars for the CO₂ absorption capacity are the standard errors from three continuous flow mode experiments.

FIG. 5 depicts a graph showing the effect of anion species on CO₂ concentration during the moisture-swing process. “High humidity” represents a concentration of 20 parts/thousand H₂O in air, and “low humidity” represents 0.1 parts/thousand H₂O.

FIG. 6 depicts a bar graph showing absorption half-time and rate for resins loaded with various anions.

FIG. 7 depicts a bar graph showing moisture-swing CO₂ capture capacity and rate for resins loaded with different compositions of borate and carbonate. Mixed borate and carbonate showed a much higher capacity and rate. Error bars are the standard errors from five cycles in the moisture-swing CO₂ capture experiments.

FIG. 8 illustrates a schematic diagram showing the resin morphology, water/CO₂ diffusion in mesopores and macropores, and anions retained in the highly confined polymer micropores.

FIG. 9 depicts a bar graph showing the effect of resins on the moisture-swing CO₂ capture capacity and rate.

FIG. 10 is a plot showing short-range order of resins determined by pair-distribution function analysis.

FIG. 11 depicts a graph showing water uptake by resins at H₂O concentration of 20.0 parts/thousand.

FIG. 12 illustrates a system diagram of a moisture-swing sorbent system, according to aspects of the present disclosure.

FIG. 13 illustrates a system diagram of a moisture-swing sorbent system, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Moisture-swing direct air capture technology represents an alternative approach to conventional carbon dioxide separation methods that typically rely on energy-intensive temperature or pressure swings for sorbent regeneration. In contrast to these traditional approaches, moisture-swing sorbents operate through a fundamentally different mechanism where carbon dioxide capture and release are controlled by changes in humidity rather than thermal or pressure cycling. This humidity-driven process may offer substantial energy savings compared to conventional direct air capture systems that require temperatures ranging from 300° C. to 900° C. for sorbent regeneration. The moisture-swing approach may reduce the energy required to remove a ton of carbon dioxide from approximately 4.1 gigajoules using conventional techniques to as low as 0.7 gigajoules, representing a significant reduction in operational energy requirements.

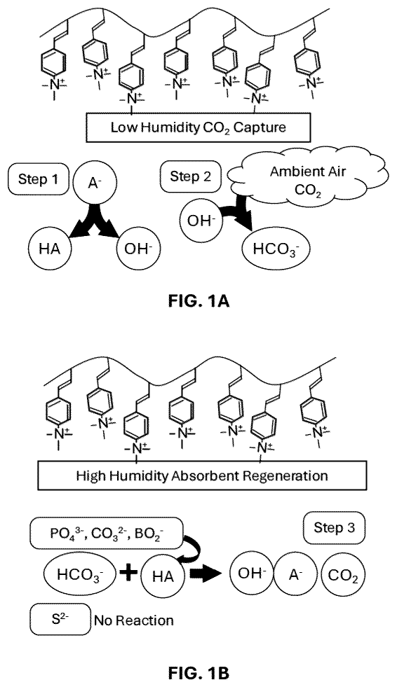

The operating principle of moisture-swing direct air capture involves a two-phase process where sorbent materials capture carbon dioxide from ambient air at low humidity conditions and subsequently release the captured carbon dioxide when exposed to high humidity environments. Referring to FIG. 1A, the carbon dioxide capture process occurs through a two-step chemical reaction mechanism. In the first step, water molecules react with anions present in the sorbent material through hydrolysis to produce hydroxide anions that serve as active sites for carbon dioxide capture. The second step involves the reaction of these hydroxide anions with incoming carbon dioxide from ambient air to form bicarbonate species, effectively removing carbon dioxide from the gas stream.

The regeneration phase of the moisture-swing process operates under high humidity conditions where the captured carbon dioxide is released from the sorbent material. As shown in FIG. 1B, the regeneration process involves chemical reactions between bicarbonate species and protonated anions in the presence of water molecules. During this high humidity phase, the interaction between bicarbonate and protonated acid species results in the formation of hydroxide ions, corresponding anions, and carbon dioxide as products. The released carbon dioxide may then be collected and directed to storage or utilization systems, while the sorbent material is regenerated for subsequent capture cycles.

Moisture-swing sorbent systems may operate effectively with ambient air containing carbon dioxide concentrations of approximately 417 parts per million at humidity levels around 15% during the capture phase. The dual-phase operation allows these systems to function in environments with natural humidity variations, potentially enabling passive operation in climates that experience regular daily humidity fluctuations. In some cases, moisture-swing sorbents may achieve dual functionality by simultaneously capturing carbon dioxide from ambient air and harvesting water vapor from the atmosphere. This dual capability may address both carbon capture objectives and water scarcity challenges, particularly in regions where atmospheric water harvesting could supplement local water supplies while contributing to carbon dioxide removal efforts.

A moisture-swing sorbent composition may comprise an ion exchange resin loaded with a plurality of ions, where the plurality of ions comprises a plurality of borate ions. The incorporation of borate ions into ion exchange resin materials represents a departure from conventional moisture-swing sorbents that typically utilize single-anion systems such as carbonate-only or phosphate-only configurations. Borate ions may participate in the moisture-swing mechanism through hydrolysis reactions that generate hydroxide anions capable of carbon dioxide capture, and may also provide catalytic promotion of direct carbon dioxide and water reactions to form bicarbonate species. The presence of borate ions in the ion exchange resin may contribute to enhanced absorption kinetics and improved overall capture performance compared to traditional single-anion moisture-swing sorbents. In some cases, the borate-loaded ion exchange resin may achieve moisture-swing carbon dioxide capacities while maintaining reversible operation through humidity-controlled regeneration cycles.

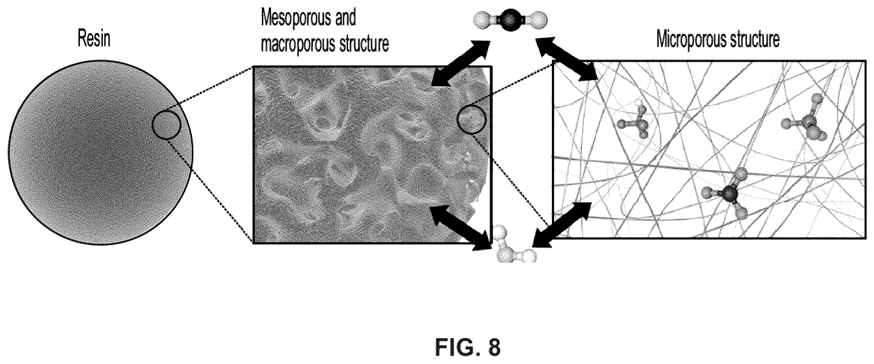

The moisture-swing sorbent composition may utilize a mixed-anion approach where the plurality of ions consists of a plurality of carbonate ions and a plurality of borate ions. This dual-anion configuration may provide synergistic effects that enhance both the capacity and rate of carbon dioxide capture compared to individual carbonate-only or borate-only systems. Referring to FIG. 8, the mixed-anion sorbent composition may be incorporated within a mesoporous and macroporous structure that facilitates both carbon dioxide capture and ambient water harvesting functionality. The carbonate ions may contribute to the moisture-swing mechanism through established hydrolysis and neutralization pathways, while the borate ions may provide additional active sites and potentially catalytic enhancement of carbon dioxide absorption processes. The combination of carbonate and borate ions within the ion exchange resin matrix may result in improved moisture-swing carbon dioxide capacity and absorption rates compared to single-anion alternatives.

The ion exchange resin component of the moisture-swing sorbent composition may provide the structural framework for retaining and organizing the plurality of ions within a porous matrix. Ion exchange resins may comprise polymeric materials with quaternary ammonium functional groups that serve as cation sites for maintaining charge neutrality with the anionic species. The resin structure may contain microporous regions where the mixed anions are retained, as well as mesoporous and macroporous networks that facilitate gas and water transport during moisture-swing operation. In some cases, the ion exchange resin may be selected from commercially available materials such as strongly basic anion exchange resins with appropriate pore size distributions and surface area characteristics. The resin matrix may provide confinement effects that influence the local chemical microenvironments surrounding the borate and carbonate ions, potentially affecting their hydrolysis behavior and interactions with water molecules during moisture-swing cycles.

The mixed-anion approach utilized in the moisture-swing sorbent composition may offer advantages over conventional single-anion systems through complementary mechanisms of carbon dioxide capture and release. Borate ions may exhibit different basicity characteristics compared to carbonate ions, potentially providing access to alternative reaction pathways during the moisture-swing process. The presence of both ion types within the same resin matrix may create diverse active site environments that can accommodate varying humidity conditions and carbon dioxide concentrations. In some cases, the mixed-anion composition may demonstrate enhanced reversibility during regeneration cycles, where the different thermodynamic properties of borate and carbonate species may contribute to more complete carbon dioxide release under high humidity conditions. The dual-anion system may also provide improved stability over multiple moisture-swing cycles compared to single-anion configurations that may experience gradual degradation or loss of active sites during repeated operation.

The ion exchange resin component of the moisture-swing sorbent composition may comprise strongly basic polymeric materials that provide the structural foundation for anion loading and retention. Ion exchange resins may contain quaternary ammonium functional groups that serve as positively charged sites within the polymer matrix, creating electrostatic attraction points for anionic species. The quaternary ammonium groups may be distributed throughout the resin structure, providing charge neutrality when paired with counterions such as borate, carbonate, or phosphate. Sulfide and acetate species showed relatively poor performance. The resin morphology may include interconnected porous networks that facilitate gas and water transport while maintaining confinement of the loaded anions within microporous regions. In some cases, the confinement effects within these microporous regions may influence the local chemical microenvironments surrounding the anions, potentially affecting their hydrolysis behavior and interactions with water molecules during moisture-swing operation.

The selection of anion species for loading into the ion exchange resin may be based on their basicity characteristics, which may be quantified through pKₐ values that indicate the tendency of each anion to undergo hydrolysis reactions. Phosphate ions may exhibit the highest basicity among the evaluated anions with a pKₐ value of 12.32, potentially providing enhanced hydroxide generation capacity during the moisture-swing process. Sulfide ions may demonstrate a pKₐ value of 11.96, indicating strong basicity that may result in extensive hydrolysis reactions. Carbonate ions may possess a pKₐ value of 10.33, representing moderate basicity that may balance hydroxide generation with regeneration reversibility. Borate ions may exhibit a pKₐ value of 9.24, providing moderate basicity while potentially offering catalytic enhancement of carbon dioxide absorption processes. Acetate ions may demonstrate the lowest basicity with a pKₐ value of 4.76, which may result in insufficient hydroxide generation for effective carbon dioxide capture.

Phosphate-loaded ion exchange resins may provide enhanced carbon dioxide capture capacity compared to carbonate-loaded alternatives due to the higher basicity of phosphate ions. The manufacturing process for phosphate-loaded resins may involve the use of potassium phosphate as the anion source, where the phosphate ions may replace the original chloride counterions through ion exchange mechanisms. Phosphate ions may undergo hydrolysis reactions more readily than carbonate ions, potentially generating higher concentrations of hydroxide anions that serve as active sites for carbon dioxide capture. In some cases, phosphate-loaded resins may demonstrate moisture-swing carbon dioxide capacities that exceed those of carbonate-only systems, though the enhanced basicity may also affect the regeneration characteristics under high humidity conditions. The phosphate ions may participate in neutralization reactions during the regeneration phase, where the interaction between bicarbonate species and protonated phosphate may facilitate carbon dioxide release.

Sulfide-loaded ion exchange resins may exhibit limited moisture-swing capacity despite the high basicity of sulfide ions, which may be attributed to excessive interactions between sulfide species and water molecules. The manufacturing process for sulfide-loaded resins may utilize sodium sulfide as the anion source during the ion exchange procedure. Sulfide ions may undergo extensive hydrolysis reactions due to their high pKₐ value of 11.96, potentially generating substantial quantities of hydroxide anions for carbon dioxide capture. However, the strong water interactions of sulfide ions may interfere with the regeneration process, where the protonated sulfide species may not effectively participate in neutralization reactions with bicarbonate. In some cases, sulfide-loaded resins may capture carbon dioxide during the absorption phase but may demonstrate poor reversibility during humidity-driven regeneration, resulting in limited moisture-swing capacity compared to other anion types.

Acetate-loaded ion exchange resins may demonstrate no carbon dioxide capture capability due to the insufficient basicity of acetate ions. The manufacturing process for acetate-loaded resins may involve sodium acetate as the anion source for loading into the ion exchange resin matrix. Acetate ions may possess a pKₐ value of 4.76, which may be too low to promote significant hydrolysis reactions under the humidity conditions typically encountered in moisture-swing operation. The limited basicity of acetate ions may result in minimal hydroxide generation, preventing the formation of active sites for carbon dioxide capture. In some cases, acetate-loaded resins may serve as control materials in experimental evaluations, demonstrating the relationship between anion basicity and moisture-swing performance while confirming that adequate basicity may be necessary for effective carbon dioxide capture functionality.

Commercial ion exchange resins may provide specific structural and performance characteristics that influence moisture-swing behavior. AMBERCHROM™ 1×4 Ion Exchange Resin from Millipore Sigma may represent one type of ion exchange resin with particular surface area and pore characteristics that may affect anion loading and gas transport properties. AMBERCHROM™ 1×4 Ion Exchange Resin may exhibit a surface area of approximately 267 m²/g with predominantly small pores having an average radius of approximately 3 nm. The resin morphology may include smaller particle sizes with rough surface textures that may influence the accessibility of anions within the porous structure. Referring to FIG. 10, the pair distribution function analysis may reveal the local structural characteristics of different resin types, where AMBERCHROM™ 1×4 Ion Exchange Resin may demonstrate specific patterns at characteristic bond lengths corresponding to benzene rings and alkyl chains within the polymer matrix.

AMBERSEP® 900 Ion Exchange Resin may represent an alternative ion exchange resin with different morphological characteristics compared to AMBERCHROM™ 1×4 Ion Exchange Resin. AMBERSEP® 900 Ion Exchange Resin may possess larger particle diameters and may exhibit a bimodal pore size distribution that includes both small pores with radii of approximately 3 nm and large pores with radii ranging from 35 nm to 135 nm. The surface area of AMBERSEP® 900 Ion Exchange Resin may be approximately 255 m²/g, which may be comparable to AMBERCHROM™ 1×4 Ion Exchange Resin despite the different pore size distribution. The bimodal pore structure of AMBERSEP® 900 Ion Exchange Resin may provide enhanced water transport capabilities compared to resins with predominantly microporous structures. As shown in FIG. 10, the pair distribution function analysis may indicate similar local structural features between different resin types, suggesting that the microporous regions may control the anion hydrolysis reactions while the macroporous regions may influence transport phenomena. Referring to FIG. 11, the water uptake characteristics may differ between resin types, where AMBERSEP® 900 Ion Exchange Resin may demonstrate higher water absorption capacity and faster uptake rates compared to AMBERCHROM™ 1×4 Ion Exchange Resin, potentially due to the presence of macroporous channels that facilitate water transport within the resin matrix.

The surface area characteristics of the moisture-swing sorbent composition may vary depending on the specific ion exchange resin selected and the processing conditions used during anion loading procedures. Surface area measurements may be determined through gas sorption experiments that evaluate the accessible surface within the porous resin matrix. In some cases, the moisture-swing sorbent composition (and particularly the ion exchange resin) may have a surface area of less than 200 m²/g, which may correspond to resin materials with limited porosity or dense polymer structures that restrict gas access to internal surfaces. These lower surface area configurations may still provide functional moisture-swing behavior when the available surface area contains adequate anion loading densities and appropriate pore connectivity for gas and water transport. The reduced surface area may result in lower absolute carbon dioxide capture capacities per unit mass, though the moisture-swing mechanism may remain operational through the hydrolysis and neutralization reactions occurring at accessible anion sites.

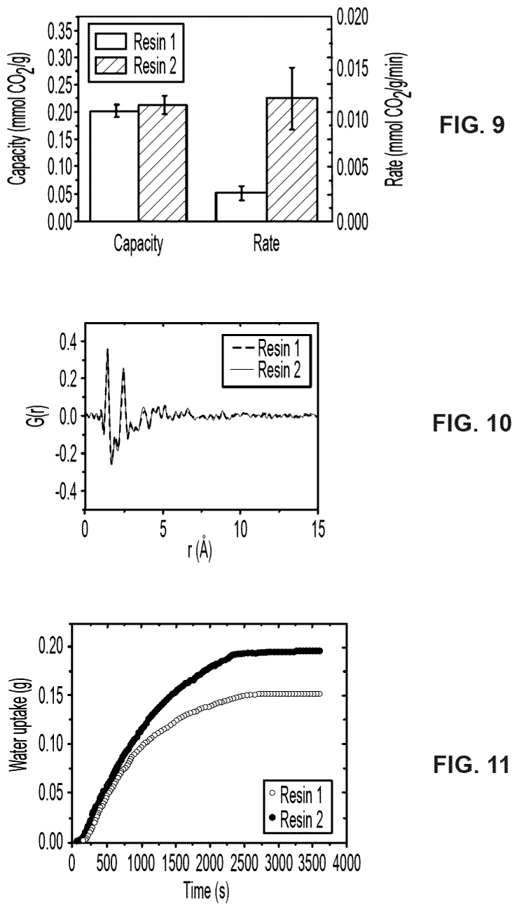

Alternative surface area configurations may provide enhanced performance characteristics through increased accessible surface area within the resin matrix. The moisture-swing sorbent composition (and particularly the ion exchange resin) may have a surface area of 200-300 m²/g, representing a moderate surface area range that may balance accessibility with structural integrity of the ion exchange resin. This surface area range may correspond to resin materials with well-developed porous networks that provide adequate access to loaded anions while maintaining mechanical stability during moisture-swing cycling. Referring to FIG. 9, the capacity and rate measurements may demonstrate how different resin types with varying surface area characteristics may influence the overall performance of moisture-swing sorbent systems. The moderate surface area range may provide sufficient anion accessibility for effective hydrolysis reactions while avoiding potential issues associated with excessive porosity that might compromise resin durability or anion retention.

Higher surface area configurations may offer enhanced carbon dioxide capture performance through increased anion accessibility and improved gas transport characteristics. In some cases, the moisture-swing sorbent composition (and particularly the ion exchange resin) may have a surface area of more than 300 m²/g, which may correspond to highly porous resin structures with extensive internal surface development. These elevated surface area materials may provide increased anion loading capacity and enhanced accessibility of active sites for carbon dioxide capture reactions. The higher surface area may facilitate improved gas diffusion within the resin matrix, potentially reducing mass transfer limitations that might otherwise restrict the rate of carbon dioxide absorption. However, the increased porosity associated with higher surface areas may also affect the mechanical properties of the resin material and may influence the water uptake characteristics during humidity-driven regeneration cycles.

The pore structure of the moisture-swing sorbent composition may comprise multiple pore size populations that serve different functions during moisture-swing operation. The moisture-swing sorbent component may have a plurality of small pores having an average pore radius of less than 10 nm, which may provide confinement environments for anion retention and localized chemical reactions. These small pores may create microporous regions where borate and carbonate ions may be retained in close proximity to quaternary ammonium sites within the ion exchange resin matrix. The confined environment within small pores may influence the local chemical microenvironments surrounding the anions, potentially affecting their hydrolysis behavior and interactions with water molecules during moisture-swing cycles. In some cases, the small pore network may control the extent of anion hydrolysis reactions and may determine the moisture-swing carbon dioxide capacity through the accessibility of confined anion sites.

The pore structure may also include larger pore populations that facilitate transport phenomena during moisture-swing operation. The moisture-swing sorbent component may have a plurality of large pores having an average pore radius of at least 25 nm, which may provide pathways for gas and water transport within the resin matrix. These large pores may serve as transport channels that allow carbon dioxide and water vapor to access the smaller pore regions where anion-mediated reactions occur. The presence of large pores may reduce diffusion limitations that might otherwise restrict the rate of carbon dioxide absorption or the efficiency of humidity-driven regeneration. In some cases, the large pore network may influence the water uptake characteristics of the resin material, potentially affecting the rate at which humidity changes can penetrate the resin structure and initiate regeneration reactions.

Specific pore size ranges may provide optimized performance characteristics for moisture-swing applications through balanced transport and confinement effects. The average pore radius of the plurality of small pores may be 2 nm-4 nm, representing a size range that may provide adequate confinement for anion retention while allowing water molecule access for hydrolysis reactions. This small pore size range may create environments where anions experience confinement effects that influence their chemical behavior while maintaining sufficient accessibility for moisture-driven reactions. The average pore radius of the plurality of large pores may be 35 nm-135 nm, which may provide effective transport pathways for gas and water movement within the resin matrix. This large pore size range may facilitate rapid equilibration between the external gas phase and the internal pore network, potentially improving the response time of the moisture-swing system to humidity changes and enhancing the overall efficiency of carbon dioxide capture and release cycles.

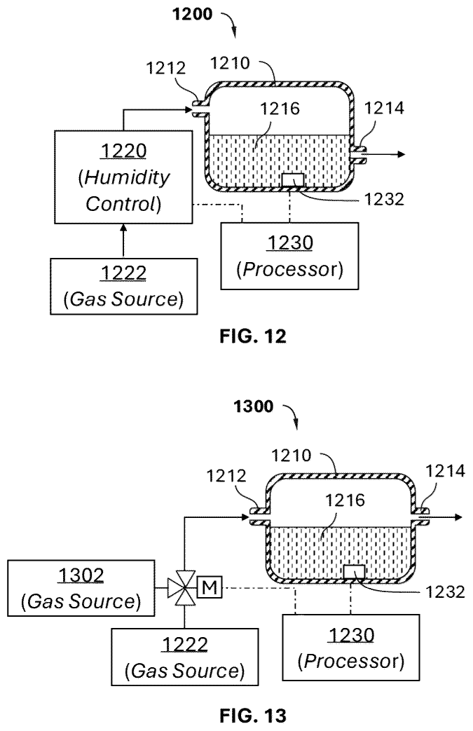

A moisture-swing sorbent system may comprise the moisture-swing sorbent composition and additional components configured to facilitate carbon dioxide capture and regeneration operations. Referring to FIG. 12, a system 1200 may include a housing 1210 that provides structural containment and flow management for the moisture-swing sorbent composition during operation. The housing 1210 may define internal volumes and flow pathways that direct gas streams through or over the sorbent material while maintaining controlled environmental conditions. An inlet port 1212 may be positioned within the housing 1210 to receive gas streams from external sources and direct the gas flow toward the sorbent material. An outlet port 1214 may be configured to allow processed gas streams to exit the housing 1210 after contact with the sorbent material. A moisture-swing sorbent 1216 may be contained within the housing 1210 and may comprise the ion exchange resin loaded with borate ions or mixed borate and carbonate ions as described previously.

The housing 1210 may surround the moisture-swing sorbent composition and may provide physical containment that maintains the sorbent material in a defined configuration during moisture-swing operation. The housing 1210 may comprise materials that are chemically compatible with the operating environment and may resist corrosion or degradation when exposed to varying humidity conditions and carbon dioxide concentrations. In some cases, the housing 1210 may include internal structures or supports that maintain the position of the moisture-swing sorbent 1216 while allowing gas flow through the sorbent bed. The housing 1210 may also provide access points for monitoring equipment or control systems that track the performance of the moisture-swing process. The structural design of the housing 1210 may accommodate thermal expansion or contraction that may occur during humidity cycling while maintaining gas-tight seals at connection points.

The inlet port 1212 may be configured to receive a gas and direct the gas over or through the moisture-swing sorbent composition during carbon dioxide capture and regeneration cycles. The inlet port 1212 may include connection features that allow attachment to external gas supply systems or atmospheric air intake systems. Gas flow through the inlet port 1212 may be controlled through external flow regulation equipment that manages the rate and composition of gas streams entering the housing 1210. In some cases, the inlet port 1212 may include flow distribution features that promote uniform gas contact with the moisture-swing sorbent 1216 throughout the sorbent bed. The inlet port 1212 may also accommodate gas streams with varying humidity levels, allowing the system 1200 to operate with both dry gas streams during carbon dioxide capture phases and humid gas streams during regeneration phases.

The moisture-swing sorbent system may operate in continuous flow mode where air containing carbon dioxide flows across the sorbent material continuously during the capture phase. In continuous flow operation, ambient air or other carbon dioxide-containing gas streams may enter through the inlet port 1212 and pass through or over the moisture-swing sorbent 1216 in a steady flow pattern. The continuous flow configuration may allow for real-time carbon dioxide removal from gas streams while maintaining consistent contact between the gas phase and the sorbent material. The outlet port 1214 may discharge processed gas streams that have reduced carbon dioxide concentrations compared to the inlet gas composition. Continuous flow operation may provide advantages for applications where steady-state carbon dioxide removal may be desired, such as atmospheric air processing or industrial gas treatment applications.

Alternative operational modes may include batch mode configurations where carbon dioxide-saturated resins are placed in a sample chamber and humidity may be controlled for regeneration purposes. In batch mode operation, the moisture-swing sorbent 1216 may be loaded with carbon dioxide during an initial capture phase, followed by a regeneration phase where humidity conditions within the housing 1210 may be adjusted to promote carbon dioxide release. The batch mode configuration may allow for more precise control of environmental conditions during each phase of the moisture-swing cycle. Gas flow through the inlet port 1212 and outlet port 1214 may be managed differently during batch operation, where gas streams may be introduced intermittently or at controlled intervals rather than continuously. Batch mode operation may provide advantages for experimental evaluation of sorbent performance or for applications where cyclic operation may be preferred over continuous processing.

The housing 1210 may incorporate a packed bed reactor configuration for containing the solid-state sorbent material during carbon dioxide capture operations. In a packed bed arrangement, the moisture-swing sorbent 1216 may be distributed within the housing 1210 in a manner that creates a porous bed through which gas streams may flow. The packed bed configuration may provide high surface area contact between the gas phase and the sorbent material while maintaining reasonable pressure drop characteristics across the sorbent bed. Gas flow through the packed bed may follow tortuous pathways that promote mixing and contact between carbon dioxide molecules and the active anion sites within the sorbent material. The packed bed reactor configuration may be suitable for applications where high gas throughput may be desired while maintaining effective carbon dioxide capture performance.

Large tank configurations may provide alternative containment arrangements for the sorbent material during carbon dioxide capture operations. In large tank implementations, the housing 1210 may comprise expanded internal volumes that accommodate substantial quantities of the moisture-swing sorbent 1216 for industrial-scale carbon dioxide removal applications. The large tank configuration may include internal flow distribution systems that promote uniform gas contact throughout the expanded sorbent volume. Gas entry through the inlet port 1212 may be managed through multiple distribution points or flow conditioning systems that prevent channeling or uneven flow patterns within the large tank volume. The large tank approach may provide advantages for applications where high carbon dioxide removal capacity may be desired and where the physical footprint of the system may accommodate expanded housing dimensions.

The moisture-swing sorbent system may include additional control and monitoring components that facilitate automated operation and performance optimization during carbon dioxide capture and regeneration cycles. Referring to FIG. 13, a system 1300 may incorporate a control processor 1230 that manages the operational parameters of the moisture-swing process through coordinated control of gas flow, humidity conditions, and timing sequences. The control processor 1230 may be configured to control the moisture-swing sorbent system such that a wet gas may be passed over or through the moisture-swing sorbent composition when the moisture-swing sorbent composition may be dry, and a dry gas may be passed over or through the moisture-swing sorbent composition when the moisture-swing sorbent composition may be wet. This alternating gas flow control may enable the system 1300 to maintain optimal conditions for both carbon dioxide capture and sorbent regeneration phases. The control processor 1230 may utilize feedback from monitoring equipment to determine the appropriate timing for transitioning between wet and dry gas flow conditions based on the saturation state of the moisture-swing sorbent 1216.

A sensor 1232 may provide real-time monitoring capabilities that enable the control processor 1230 to assess the performance and operational status of the moisture-swing sorbent system during operation. The sensor 1232 may be positioned to monitor various parameters within the system 1300, including gas composition, humidity levels, temperature conditions, or sorbent saturation states. In some cases, the sensor 1232 may comprise a gas analyzer such as an LI-850 CO₂/H₂O Analyzer for monitoring concentrations of carbon dioxide and water vapor within the gas streams entering and exiting the housing 1210. The gas analyzer functionality may provide quantitative measurements of carbon dioxide removal efficiency and water vapor content that may be used by the control processor 1230 to optimize operational parameters. The sensor 1232 may communicate measurement data to the control processor 1230 through wired or wireless communication interfaces, enabling automated adjustment of system parameters based on real-time performance feedback.

Gas supply systems may provide controlled delivery of gas streams with varying compositions and humidity levels to support both capture and regeneration phases of the moisture-swing process. A gas source 1222 may supply gas streams to the inlet port 1212 of the housing 1210 through flow control systems that regulate the rate and composition of gas delivery. The gas source 1222 may comprise atmospheric air intake systems for direct air capture applications, or may include stored gas supplies for controlled experimental or industrial processing applications. In some cases, the gas may be air containing ambient carbon dioxide concentrations that may be processed for carbon dioxide removal during the capture phase. Alternative configurations may utilize gas streams other than air, where the gas source 1222 may provide industrial process gases, flue gases, or other carbon dioxide-containing streams that may benefit from moisture-swing carbon dioxide removal. The gas source 1222 may include flow regulation equipment that allows the control processor 1230 to manage gas delivery rates and timing sequences during automated operation.

Multiple gas supply systems may enable more sophisticated control of gas composition and humidity conditions during moisture-swing operation. A first gas source 1302 may provide gas streams with different characteristics compared to the gas source 1222, allowing the system 1300 to alternate between different gas compositions during capture and regeneration phases. The first gas source 1302 may supply dry gas streams with low humidity content that may be utilized during carbon dioxide capture phases when the moisture-swing sorbent 1216 may be in a regenerated state. The gas source 1222 may provide humid gas streams with elevated water vapor content that may be used during regeneration phases to promote carbon dioxide release from the saturated sorbent material. The control processor 1230 may coordinate the operation of both the first gas source 1302 and the gas source 1222 to provide alternating gas flow conditions that optimize the moisture-swing process. Gas mixing or switching systems may be incorporated between the gas sources and the inlet port 1212 to enable smooth transitions between different gas stream compositions.

A humidity control 1220 system may provide precise management of water vapor content in gas streams entering the housing 1210 during moisture-swing operation. The humidity control 1220 may be positioned between the gas sources and the inlet port 1212 to condition gas streams before contact with the moisture-swing sorbent 1216. In some cases, the humidity control 1220 may comprise a dew point generator such as an LI-610 Portable Dew Point Generator for controlling humidity in the experimental setup, providing precise control over water vapor concentrations in gas streams. The humidity control 1220 may enable the system 1300 to generate gas streams with humidity levels ranging from near-zero water vapor content for carbon dioxide capture phases to elevated humidity levels approaching saturation for regeneration phases. The control processor 1230 may coordinate the operation of the humidity control 1220 with the timing of gas flow cycles to ensure appropriate humidity conditions may be maintained throughout each phase of the moisture-swing process.

The humidity control 1220 system may be configured to prevent water condensation within the housing 1210 when the dew point in the gas may be higher than room temperature during high-humidity regeneration phases. Water condensation within the housing 1210 may interfere with gas flow patterns, reduce the effectiveness of gas-sorbent contact, or cause operational difficulties during moisture-swing cycling. The humidity control 1220 may include temperature management capabilities that maintain gas temperatures above the dew point temperature while providing the elevated humidity levels needed for sorbent regeneration. In some cases, the humidity control 1220 may incorporate heating elements or temperature conditioning systems that warm humid gas streams before delivery to the inlet port 1212. The prevention of condensation may maintain consistent gas flow characteristics and may prevent liquid water accumulation that might otherwise interfere with the moisture-swing mechanism or cause mechanical issues within the housing 1210.

The spatial relationships between system components may be configured to optimize performance and facilitate maintenance access during operation of the moisture-swing sorbent system. The control processor 1230 may be positioned external to the housing 1210 to provide protection from humidity variations and temperature fluctuations that may occur within the gas processing environment. Communication connections between the control processor 1230 and the sensor 1232 may allow monitoring and control functions while maintaining physical separation between electronic components and the moisture-swing processing environment. The humidity control 1220 may be positioned upstream of the inlet port 1212 in the gas flow pathway to ensure proper conditioning of gas streams before contact with the moisture-swing sorbent 1216. The gas source 1222 and the first gas source 1302 may be connected to the humidity control 1220 through flow control valves or switching systems that enable the control processor 1230 to select appropriate gas sources for each phase of the moisture-swing cycle. The sensor 1232 may be positioned to monitor gas streams at various points within the system 1300, including locations upstream and downstream of the housing 1210 to provide comprehensive performance monitoring capabilities.

Moisture-swing sorbent systems may operate through various operational modes that accommodate different environmental conditions and application requirements. The operational flexibility of these systems may enable deployment in diverse settings ranging from controlled laboratory environments to field installations where natural environmental variations may be utilized to drive the moisture-swing process. The selection of operational mode may depend on factors such as the availability of humidity control equipment, the desired carbon dioxide processing capacity, and the environmental conditions present at the installation location. Each operational mode may provide distinct advantages and may be optimized for specific performance objectives or operational constraints.

Continuous flow mode operation may provide steady-state carbon dioxide removal from gas streams through maintained contact between flowing gas and the moisture-swing sorbent material. In continuous flow configurations, gas streams may enter the system at controlled flow rates and may pass through or over the sorbent material in a consistent manner throughout the capture phase. The continuous flow approach may enable processing of large volumes of gas while maintaining predictable carbon dioxide removal performance. Gas streams utilized in continuous flow mode may comprise air containing 417 parts per million carbon dioxide at 15 percent humidity during the capture phase, representing atmospheric conditions that may be encountered in ambient air processing applications. The specific carbon dioxide concentration and humidity level may provide optimal conditions for the hydrolysis reactions that generate hydroxide anions within the loaded ion exchange resin matrix. The 15 percent humidity level may be sufficient to support anion hydrolysis while remaining below the threshold that would trigger premature regeneration of the sorbent material.

The continuous flow operational mode may maintain consistent environmental conditions within the sorbent bed through controlled gas delivery systems that regulate flow rate, composition, and humidity content. Gas flow patterns within the sorbent bed may be designed to promote uniform contact between carbon dioxide molecules and the active anion sites distributed throughout the ion exchange resin matrix. The residence time of gas within the sorbent bed may be adjusted through flow rate control to optimize carbon dioxide capture efficiency while maintaining reasonable pressure drop characteristics across the system. Temperature conditions during continuous flow operation may be maintained at ambient levels to avoid thermal effects that might interfere with the moisture-swing mechanism. The continuous nature of gas flow may enable real-time monitoring of carbon dioxide removal performance through analysis of inlet and outlet gas compositions.

Batch mode operation may provide enhanced control over environmental conditions during both carbon dioxide capture and sorbent regeneration phases through sequential processing cycles. In batch mode configurations, the moisture-swing sorbent material may be exposed to controlled gas environments for defined time periods that allow complete saturation during the capture phase followed by complete regeneration during the humidity-driven release phase. The batch approach may enable precise management of humidity conditions throughout each phase of the moisture-swing cycle without the complications associated with continuous gas flow during environmental transitions. Gas composition and humidity levels may be adjusted independently during each batch cycle to optimize the performance of both capture and regeneration processes. The batch mode may provide advantages for applications where complete carbon dioxide recovery may be desired or where detailed performance characterization may be needed.

Batch mode operation may accommodate humidity levels ranging from near-zero water vapor content during the initial capture phase to elevated humidity approaching 90 percent during the regeneration phase. The humidity range utilized in batch mode may span from approximately 0 percent relative humidity at the beginning of the capture cycle to around 90 percent relative humidity during the peak regeneration conditions. The low humidity conditions at the start of each batch cycle may promote anion hydrolysis reactions that generate hydroxide anions for carbon dioxide capture, while the elevated humidity conditions during regeneration may facilitate the neutralization reactions that release captured carbon dioxide from the sorbent material. The transition between low and high humidity conditions may be controlled through humidity generation equipment that can produce the full range of water vapor concentrations needed for effective moisture-swing operation. The batch mode approach may allow sufficient time for equilibration at each humidity level, ensuring complete capture and regeneration reactions throughout the sorbent bed.

Natural humidity cycling may provide an alternative operational approach that utilizes environmental humidity variations to drive the moisture-swing process without external humidity control equipment. Systems operated in climates with daily humidity shifts may take advantage of natural humidity changes for absorption and desorption cycles, where the diurnal variation in atmospheric water vapor content may provide the driving force for moisture-swing operation. Morning and evening periods may typically exhibit lower humidity levels that may be suitable for carbon dioxide capture phases, while midday or nighttime periods may provide elevated humidity conditions that may promote sorbent regeneration. The natural humidity cycling approach may reduce the energy requirements associated with artificial humidity control while providing effective carbon dioxide capture performance in suitable climatic conditions.

The implementation of natural humidity cycling may require careful consideration of local climate patterns and seasonal variations that may affect the reliability and consistency of moisture-swing operation. Geographic locations with predictable daily humidity fluctuations may provide optimal conditions for natural cycling, where the magnitude and timing of humidity changes may be sufficient to drive complete capture and regeneration cycles. Coastal regions, desert environments, or areas with significant temperature variations between day and night may exhibit humidity patterns that may be suitable for natural moisture-swing operation. The system design for natural humidity cycling may incorporate atmospheric air intake systems that expose the sorbent material directly to ambient environmental conditions without intermediate humidity conditioning. Monitoring equipment may track ambient humidity levels and carbon dioxide concentrations to optimize the timing of capture and regeneration phases based on natural environmental cycles.

Control methods for moisture-swing sorbent systems may coordinate the timing and sequencing of gas flow conditions to optimize carbon dioxide capture and regeneration performance throughout operational cycles. Gas flow control may involve alternating between different humidity conditions based on the saturation state of the sorbent material and the desired operational objectives. During carbon dioxide capture phases, gas flow may be directed through the sorbent bed under low humidity conditions that promote anion hydrolysis and hydroxide generation for carbon dioxide absorption. The transition to regeneration phases may involve switching to high humidity gas streams that facilitate neutralization reactions and carbon dioxide release from the saturated sorbent material. The timing of these transitions may be based on monitoring data that indicates the saturation level of the sorbent or the carbon dioxide removal efficiency of the system.

Advanced control methods may incorporate feedback systems that automatically adjust operational parameters based on real-time performance measurements and environmental conditions. Automated control systems may monitor carbon dioxide concentrations, humidity levels, and sorbent saturation states to determine optimal timing for transitions between capture and regeneration phases. The control algorithms may account for factors such as gas flow rates, temperature conditions, and sorbent bed characteristics to optimize the duration and intensity of each operational phase. Predictive control methods may utilize historical performance data and environmental forecasts to anticipate optimal operational schedules, particularly for systems utilizing natural humidity cycling where environmental conditions may vary based on weather patterns and seasonal changes. The integration of multiple control parameters may enable adaptive operation that maintains high carbon dioxide removal efficiency while minimizing energy consumption and operational complexity.

A method of manufacturing a moisture-swing sorbent composition may provide a systematic approach for producing ion exchange resin materials loaded with mixed anions that enable moisture-swing carbon dioxide capture functionality. The manufacturing method may involve a multi-step process that creates controlled chemical environments for anion generation and subsequent loading onto polymeric resin substrates. The manufacturing approach may utilize readily available chemical precursors and conventional processing equipment to produce moisture-swing sorbent materials with reproducible performance characteristics. In some cases, the manufacturing method may be scaled from laboratory-scale synthesis procedures to industrial production processes that can generate substantial quantities of moisture-swing sorbent materials for commercial carbon dioxide capture applications. The manufacturing process may incorporate quality control measures and characterization procedures that ensure consistent anion loading densities and uniform distribution of active sites throughout the finished sorbent composition.

The manufacturing method may begin with the preparation of anion-containing solutions that provide the chemical species for loading onto ion exchange resin materials. The solution preparation phase may involve the controlled dissolution and reaction of chemical precursors in aqueous media to generate the desired anion concentrations and chemical forms. The aqueous environment may facilitate the formation of ionic species while providing a medium for subsequent ion exchange reactions with the resin substrate. Temperature and pH conditions during solution preparation may be controlled to optimize the formation of target anion species and to prevent unwanted side reactions that might interfere with the loading process. In some cases, the solution preparation may involve sequential addition of chemical precursors to achieve specific anion ratios or to control the reaction kinetics during anion formation. The resulting anion solutions may be characterized through analytical methods to confirm the concentration and chemical form of the dissolved ionic species before proceeding with the resin loading procedures.

The creation of borate ion solutions may involve the reaction of boric acid precursors with alkaline reagents to generate soluble borate species suitable for ion exchange loading. Boric acid may serve as the boron source for borate ion generation, where the acidic precursor may be converted to basic borate anions through neutralization reactions with sodium hydroxide or other alkaline materials. The stoichiometry of the boric acid and sodium hydroxide reaction may be controlled to achieve the desired borate ion concentration while maintaining appropriate pH conditions for subsequent processing steps. The reaction between boric acid and sodium hydroxide may proceed through intermediate species that eventually form stable borate anions capable of participating in ion exchange reactions with quaternary ammonium sites within the resin matrix. In some cases, the borate ion formation reaction may be conducted under controlled temperature conditions to promote complete conversion of the boric acid precursor and to prevent the formation of unwanted byproducts that might interfere with the ion exchange process.

Carbonate ion solutions may be prepared through the dissolution of carbonate salts in aqueous media to provide the carbonate anion component for mixed-anion loading procedures. Sodium carbonate may serve as a convenient source of carbonate ions, where the salt may dissolve readily in water to form carbonate anions and sodium cations in solution. The carbonate ion concentration may be controlled through the amount of sodium carbonate added to the aqueous solution, allowing precise adjustment of the carbonate content in the final anion mixture. The dissolution of sodium carbonate may result in alkaline solution conditions that may be compatible with the basic borate solutions prepared in parallel processing steps. In some cases, the carbonate solution preparation may involve pH adjustment or buffering to maintain stable chemical conditions during storage and handling prior to the ion exchange loading procedures. The carbonate ions in solution may exist in equilibrium with bicarbonate species depending on the pH and temperature conditions, though the ion exchange process may accommodate both carbonate and bicarbonate forms during the loading procedure.

The combination of borate and carbonate solutions may create mixed-anion environments that provide both anion types for simultaneous loading onto ion exchange resin materials. The mixing of separately prepared borate and carbonate solutions may allow precise control over the relative concentrations of each anion type in the final loading solution. The ratio of borate to carbonate ions in the mixed solution may be adjusted to optimize the performance characteristics of the finished moisture-swing sorbent composition. In some cases, the borate and carbonate solutions may be combined in equal molar ratios to provide balanced anion loading, while alternative formulations may utilize different ratios to emphasize the contribution of one anion type over the other. The mixed-anion solution may exhibit chemical interactions between borate and carbonate species that may influence the ion exchange behavior during the loading process. The pH and ionic strength of the mixed solution may be monitored and adjusted as needed to maintain stable chemical conditions that promote effective ion exchange reactions with the resin substrate.

Ion exchange resin particles may serve as the substrate material for anion loading during the manufacturing process, where the resin provides the polymeric matrix and quaternary ammonium sites for anion retention. The selection of appropriate ion exchange resin materials may influence the loading capacity, anion distribution, and performance characteristics of the finished moisture-swing sorbent composition. Commercial ion exchange resins may be obtained in various particle sizes, pore structures, and functional group densities that may affect the anion loading process and the resulting sorbent performance. The resin particles may be prepared for the loading process through washing or conditioning procedures that remove manufacturing residues and convert the resin to an appropriate ionic form for anion exchange. In some cases, the resin particles may be supplied in chloride form, where the chloride anions may be replaced with borate and carbonate anions during the ion exchange loading procedure. The physical characteristics of the resin particles, including particle size distribution, porosity, and mechanical strength, may be evaluated to ensure compatibility with the intended manufacturing process and end-use applications.

The ion exchange loading process may involve contacting the mixed-anion solution with the ion exchange resin particles under controlled conditions that promote anion uptake and uniform distribution throughout the resin matrix. The loading procedure may be conducted in stirred reactor systems that provide adequate mixing between the liquid and solid phases while maintaining gentle agitation that prevents mechanical damage to the resin particles. The contact time between the anion solution and the resin particles may be extended to allow complete equilibration and maximum anion loading within the available exchange sites. Temperature conditions during the loading process may be controlled to optimize the ion exchange kinetics while preventing thermal degradation of the resin material or unwanted chemical reactions involving the anion species. In some cases, the loading process may involve multiple contact stages or solution exchanges to achieve higher anion loading densities or to ensure complete replacement of the original counterions within the resin matrix. The progress of the ion exchange loading may be monitored through analysis of the solution composition or through direct characterization of the resin material to confirm anion uptake and loading uniformity.

The manufacturing process may involve a sequence of controlled chemical reactions and physical processing steps that transform individual chemical precursors into a unified moisture-swing sorbent composition with mixed-anion functionality. The process may begin with the preparation of a basic solution of borate ions through the controlled reaction of boric acid and sodium hydroxide in aqueous media. The boric acid may be added to water in measured quantities to create an acidic solution, followed by the gradual addition of sodium hydroxide to neutralize the acid and generate borate anions. The stoichiometric ratio of boric acid to sodium hydroxide may be adjusted to achieve complete conversion of the boric acid precursor while maintaining alkaline conditions that stabilize the borate ion species. The reaction may proceed through intermediate stages where partially neutralized boric acid species may exist before complete conversion to the final borate anion form. Temperature control during this reaction may prevent excessive heat generation that might affect the chemical equilibrium or cause unwanted side reactions.

The basic solution of borate ions may exhibit specific pH characteristics and ionic strength properties that influence subsequent processing steps in the manufacturing sequence. The alkaline nature of the borate solution may result from the excess sodium hydroxide used during the neutralization reaction, creating conditions that may be compatible with the addition of carbonate precursors. The borate ion concentration in the basic solution may be determined by the initial quantity of boric acid used in the reaction, allowing precise control over the final anion loading density in the finished sorbent composition. The solution may be stirred or agitated during the borate formation reaction to promote uniform mixing and complete conversion of the boric acid precursor. In some cases, the basic borate solution may be allowed to equilibrate for a defined period to ensure chemical stability before proceeding with the addition of carbonate components.

The addition of sodium carbonate to the basic solution of borate ions may create a carbonate-borate mixture that contains both anion types in controlled proportions suitable for ion exchange loading procedures. Sodium carbonate may be introduced to the borate solution in solid form, where the salt may dissolve readily in the alkaline aqueous medium to release carbonate anions. The dissolution process may be facilitated through stirring or agitation that promotes rapid mixing and uniform distribution of carbonate ions throughout the solution volume. The quantity of sodium carbonate added may be calculated based on the desired ratio of carbonate to borate ions in the final mixed-anion composition. The carbonate-borate mixture may exhibit chemical interactions between the two anion types that may influence the solution chemistry and the subsequent ion exchange behavior during resin loading. The pH of the mixed solution may remain alkaline due to the basic nature of both anion species, creating conditions that may be suitable for ion exchange reactions with quaternary ammonium sites in the resin matrix.

The carbonate-borate mixture may be characterized by specific ionic concentrations and chemical equilibria that determine the loading behavior during contact with ion exchange resin materials. The presence of both carbonate and borate anions in the same solution may create competitive ion exchange conditions where both anion types may compete for available exchange sites within the resin matrix. The relative concentrations of carbonate and borate ions may influence the final loading ratio achieved in the finished sorbent composition. The mixed-anion solution may be stable under ambient conditions, allowing for storage or transport between preparation and loading operations. In some cases, the carbonate-borate mixture may be analyzed through analytical methods to confirm the anion concentrations and to verify the absence of unwanted impurities that might interfere with the ion exchange process.

The mixing of the carbonate-borate mixture with ion exchange resin particles may form intermediate particles in solution where the anions may begin to associate with the quaternary ammonium sites within the resin matrix. The ion exchange resin particles may be added to the carbonate-borate mixture in quantities that provide adequate solution volume for complete particle wetting and anion accessibility. The initial contact between the mixed-anion solution and the resin particles may result in rapid uptake of anions at the external surfaces of the resin particles, followed by slower diffusion of anions into the internal pore structure. The intermediate particles may represent a transitional state where partial anion loading has occurred but equilibrium conditions have not yet been achieved throughout the resin matrix. The formation of intermediate particles may be accompanied by changes in solution composition as anions are removed from the liquid phase and incorporated into the resin structure.

The contact time between the carbonate-borate mixture and the ion exchange resin particles may be extended through stirring for 24 hours to ensure proper loading and uniform anion distribution throughout the resin matrix. The 24-hour contact period may provide adequate time for anion diffusion into the internal pore structure of the resin particles, allowing access to exchange sites that may not be immediately accessible during initial contact. Stirring during the 24-hour period may maintain suspension of the resin particles and may promote continuous mixing between the liquid and solid phases. The agitation rate during stirring may be controlled to provide adequate mixing while avoiding mechanical damage to the resin particles that might affect their structural integrity or performance characteristics. The extended contact time may allow the ion exchange process to approach equilibrium conditions where the anion loading density reaches maximum values based on the available exchange capacity of the resin material.

The stirring process during the 24-hour loading period may facilitate mass transfer between the solution phase and the resin particles through enhanced mixing and reduced boundary layer effects at the particle surfaces. The mechanical agitation may prevent settling of the resin particles and may maintain uniform exposure of all particle surfaces to the anion-containing solution. The stirring rate may be adjusted to provide effective mixing without creating excessive shear forces that might cause particle attrition or mechanical degradation. Temperature conditions during the 24-hour stirring period may be maintained at ambient levels to prevent thermal effects that might influence the ion exchange equilibrium or cause unwanted chemical reactions. The progress of anion loading during the stirring period may be monitored through periodic sampling and analysis of the solution composition to track the uptake of carbonate and borate ions by the resin particles.

The formation of the moisture-swing sorbent composition may involve the separation and purification of the loaded resin particles through filtering, washing, and drying operations that remove excess solution and prepare the material for use. The filtering process may involve the physical separation of the intermediate particles from the remaining carbonate-borate solution using vacuum filtration, gravity filtration, or other solid-liquid separation methods. Vacuum filtration may provide rapid separation of the loaded resin particles while removing the majority of the liquid phase that contains unreacted anions and dissolved salts. The filtering operation may utilize filter media with appropriate pore sizes that retain the resin particles while allowing the liquid phase to pass through. The filtered intermediate particles may retain some residual moisture and dissolved salts that may be removed through subsequent washing operations.

The washing of the intermediate particles may remove residual salts, unreacted precursors, and other soluble impurities that might interfere with the performance of the finished moisture-swing sorbent composition. The washing process may involve multiple rinses with deionized water or other suitable solvents that dissolve and remove unwanted materials while preserving the loaded anions within the resin matrix. The washing procedure may be conducted using the same filtration equipment used for the initial separation, where wash solutions may be applied to the filtered particles and subsequently removed through continued filtration. The number of washing cycles may be determined based on the conductivity or chemical analysis of the wash solutions, where decreasing impurity levels may indicate adequate purification. The washing process may be designed to minimize the loss of loaded anions while achieving effective removal of unwanted materials that might affect sorbent performance.

The drying of the intermediate particles may remove residual water and prepare the moisture-swing sorbent composition for storage, handling, and use in carbon dioxide capture applications. The drying process may be conducted under controlled temperature and atmospheric conditions that promote water removal while preventing thermal degradation of the resin material or loss of loaded anions. Ambient air drying may be utilized for temperature-sensitive materials, where extended drying times may be acceptable to achieve adequate moisture removal. Alternative drying methods may include oven drying at elevated temperatures, vacuum drying under reduced pressure, or freeze drying for materials that may be sensitive to thermal or oxidative conditions. The final moisture content of the dried sorbent composition may be controlled to levels that provide adequate storage stability while maintaining the structural integrity of the resin matrix.

Alternative synthesis approaches may provide access to moisture-swing sorbent compositions with different anion loading configurations that may offer varying performance characteristics for carbon dioxide capture applications. The use of potassium phosphate as an alternative precursor may enable the creation of phosphate-loaded resins through similar manufacturing procedures adapted for phosphate anion generation and loading. The potassium phosphate precursor may be dissolved directly in aqueous media to provide phosphate anions without the neutralization reactions used for borate generation. The phosphate solution may be contacted with ion exchange resin particles using similar stirring and contact time procedures, followed by filtering, washing, and drying operations that parallel the carbonate-borate manufacturing process. The resulting phosphate-loaded resin may exhibit different basicity characteristics and moisture-swing behavior compared to the mixed carbonate-borate composition.

Sodium acetate may serve as a precursor for creating acetate-loaded resins through manufacturing procedures that follow similar processing steps with modifications appropriate for acetate anion chemistry. The sodium acetate precursor may dissolve readily in aqueous media to provide acetate anions that may be contacted with ion exchange resin particles under controlled conditions. The acetate loading process may utilize similar stirring times and contact procedures, though the resulting acetate-loaded resin may exhibit limited carbon dioxide capture capability due to the lower basicity of acetate anions compared to carbonate or borate species. The acetate-loaded resin manufacturing process may serve as a control or comparison material for evaluating the performance advantages of higher basicity anion systems. The filtering, washing, and drying procedures for acetate-loaded resins may follow the same general approach used for other anion types, though the final material may not provide effective moisture-swing carbon dioxide capture functionality.

Sodium sulfide may provide an alternative precursor for creating sulfide-loaded resins that demonstrate the effects of excessive anion basicity on moisture-swing performance characteristics. The sodium sulfide precursor may be handled under controlled atmospheric conditions to prevent oxidation or other unwanted reactions that might affect the sulfide anion chemistry. The dissolution of sodium sulfide in aqueous media may create strongly alkaline conditions that may influence the ion exchange loading behavior and the final anion distribution within the resin matrix. The sulfide loading process may follow similar stirring and contact time procedures, though the resulting sulfide-loaded resin may exhibit limited moisture-swing capacity due to excessive water interactions that interfere with the regeneration process. The manufacturing of sulfide-loaded resins may provide insights into the relationship between anion basicity and moisture-swing reversibility, demonstrating that moderate basicity may be preferable to excessive basicity for effective carbon dioxide capture and release cycling.

The moisture-swing mechanism operates through a two-step chemical process that enables carbon dioxide capture at low humidity conditions followed by regeneration at elevated humidity levels. The first step involves the hydrolysis of anions present within the ion exchange resin matrix, where water molecules react with confined anions to produce hydroxide anions that serve as active sites for carbon dioxide capture. The hydrolysis reaction may be represented as A⁻·nH₂O⇄HA·xH₂O+OH⁻·yH₂O+ (n−x−y−1)H₂O, where A represents the anion species, and n, x, and y respectively represent the hydration numbers associated with the anion, the protonated anion, and the hydroxide. The extent of hydrolysis may depend on the basicity of the confined anion, with higher basicity anions such as phosphate and carbonate promoting greater hydroxide generation compared to lower basicity species. The confinement effects within the microporous regions of the ion exchange resin may influence the local chemical microenvironments surrounding the anions, potentially affecting their hydrolysis behavior and the accessibility of water molecules for the reaction.

The second step of the moisture-swing mechanism involves the reaction of hydroxide anions with carbon dioxide from ambient air to form bicarbonate species, effectively removing carbon dioxide from the gas stream. The hydroxide anions generated during the hydrolysis step may react with incoming carbon dioxide molecules according to the reaction OH⁻+CO₂→HCO₃⁻, where the strongly basic hydroxide species provide the driving force for carbon dioxide capture. The formation of bicarbonate species may occur within the confined pore structure of the ion exchange resin, where the proximity of hydroxide anions and carbon dioxide molecules may facilitate the capture reaction. The rate of carbon dioxide capture may be influenced by the concentration of available hydroxide anions, which may be determined by the extent of anion hydrolysis in the first step. The bicarbonate species formed during carbon dioxide capture may remain associated with the quaternary ammonium sites within the resin matrix, maintaining charge neutrality while storing the captured carbon dioxide in a chemically bound form.

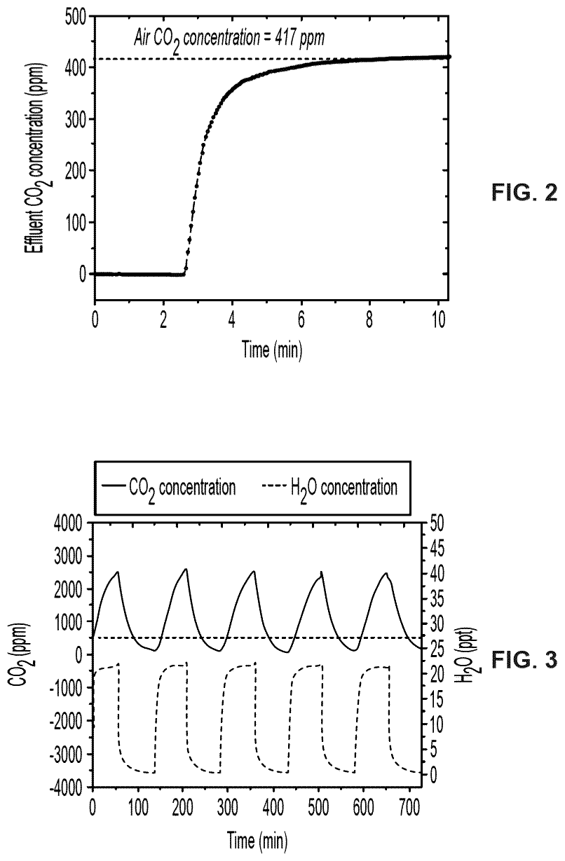

Referring to FIG. 2, the carbon dioxide capture behavior may be characterized by the temporal evolution of effluent carbon dioxide concentration as the sorbent material becomes saturated with captured carbon dioxide. The capture process may begin with effluent carbon dioxide concentrations near 0 parts per million, indicating effective removal of carbon dioxide from the incoming gas stream during the initial contact period. The effluent concentration may remain at low levels for approximately 2 minutes as the sorbent material captures carbon dioxide through the hydroxide-mediated mechanism. Between 2 and 4 minutes, the effluent carbon dioxide concentration may rise sharply as the available hydroxide sites become saturated with captured carbon dioxide, reducing the capture efficiency of the sorbent material. The concentration may continue to increase until reaching approximately 417 parts per million, which may correspond to the carbon dioxide concentration in the incoming air stream, indicating that the sorbent has reached saturation and breakthrough has occurred.

The regeneration process may occur under high humidity conditions where water molecules facilitate the release of captured carbon dioxide through neutralization reactions between bicarbonate species and protonated anions. During the high humidity phase, the increased water activity may promote the reverse of the hydrolysis reaction, where protonated anions may react with bicarbonate species to regenerate the original anion form while releasing carbon dioxide. The neutralization reaction may be represented as HA+HCO₃⁻→A⁻+H₂O+CO₂, where the protonated anion (HA) reacts with bicarbonate to produce the regenerated anion (A⁻), water, and carbon dioxide. The effectiveness of the regeneration process may depend on the thermodynamic properties of the specific anion species, where anions with appropriate basicity and water interaction characteristics may facilitate complete carbon dioxide release. The regeneration phase may restore the sorbent material to its original state, allowing for subsequent carbon dioxide capture cycles through repeated exposure to low humidity conditions.

Referring to FIG. 3, the cycling behavior of moisture-swing sorbents may demonstrate the alternating capture and regeneration phases through oscillating carbon dioxide and water concentrations over multiple operational cycles. The carbon dioxide concentration may oscillate between approximately 0 and 2500 parts per million throughout the cycling process, where the low concentration periods may correspond to carbon dioxide capture phases and the elevated concentration periods may represent regeneration phases when captured carbon dioxide may be released. The water concentration may simultaneously cycle between approximately 0 and 20 parts per thousand, indicating the humidity changes that drive the moisture-swing mechanism. The coordination between carbon dioxide and water concentration cycles may demonstrate the relationship between humidity conditions and sorbent performance, where low humidity periods may promote carbon dioxide capture while high humidity periods may facilitate regeneration. The cycling behavior may be maintained over multiple cycles, indicating the reversibility and stability of the moisture-swing mechanism under alternating humidity conditions.

The amplitude and timing of the concentration oscillations may reflect the capacity and kinetics of the moisture-swing process, where larger concentration swings may indicate higher sorbent capacity and faster transitions may suggest improved reaction kinetics. The carbon dioxide concentration during regeneration phases may reach levels significantly above the ambient concentration, demonstrating the concentration effect that occurs when captured carbon dioxide may be released into a confined volume during the regeneration process. The water concentration cycles may provide the driving force for the moisture-swing mechanism, where the transition from low to high humidity may trigger the chemical reactions that promote carbon dioxide release. The consistency of the cycling behavior over multiple cycles may indicate the durability and reversibility of the sorbent material, where maintained performance may suggest that the anion loading and resin structure may remain stable throughout repeated moisture-swing operation.

The moisture-swing sorbent composition may demonstrate dual functionality through simultaneous carbon dioxide capture and atmospheric water harvesting capabilities under appropriate operating conditions. The water absorption capacity may reach 0.1 grams of water per gram of sorbent after 1 hour of exposure under 100 percent relative humidity conditions, indicating the hygroscopic nature of the loaded anions within the ion exchange resin matrix. The water harvesting functionality may result from the affinity of the anions for water molecules, where the same hydration interactions that facilitate the moisture-swing mechanism may also enable water collection from humid air streams. The dual functionality may provide additional value for moisture-swing sorbent systems deployed in water-scarce regions, where atmospheric water harvesting may supplement local water supplies while contributing to carbon dioxide removal objectives. The water absorption process may occur simultaneously with or independently from the carbon dioxide capture mechanism, depending on the specific humidity conditions and operational parameters of the system.

The chemical interactions between anions, water molecules, and carbon dioxide within the confined environment of the ion exchange resin may determine the overall performance characteristics of the moisture-swing mechanism. The local chemical microenvironments created by the resin structure may influence the thermodynamics and kinetics of the hydrolysis and neutralization reactions that drive carbon dioxide capture and release. The accessibility of water molecules to the confined anions may affect the rate of hydroxide generation during the capture phase and the efficiency of carbon dioxide release during regeneration. The distribution of anions within the resin matrix may create varying local environments that may contribute to the overall capacity and reversibility of the moisture-swing process. The interactions between different anion types in mixed-anion systems may provide synergistic effects that enhance the performance compared to single-anion configurations, where complementary chemical properties may optimize both capture and regeneration phases of the moisture-swing cycle.

The performance characteristics of moisture-swing sorbent compositions may be evaluated through systematic measurement of carbon dioxide absorption capacities, moisture-swing capacities, and absorption rates under controlled environmental conditions. These performance metrics may provide quantitative assessments of sorbent effectiveness and may enable comparison between different anion loading configurations and resin types. The experimental evaluation of moisture-swing sorbents may involve exposure to standardized gas compositions and humidity conditions that simulate the operational environments encountered in direct air capture applications. In some cases, the performance measurements may be conducted using specialized analytical equipment that monitors gas concentrations and sorbent behavior in real-time throughout capture and regeneration cycles. The resulting performance data may inform the selection of optimal anion combinations and processing conditions for specific carbon dioxide capture applications.

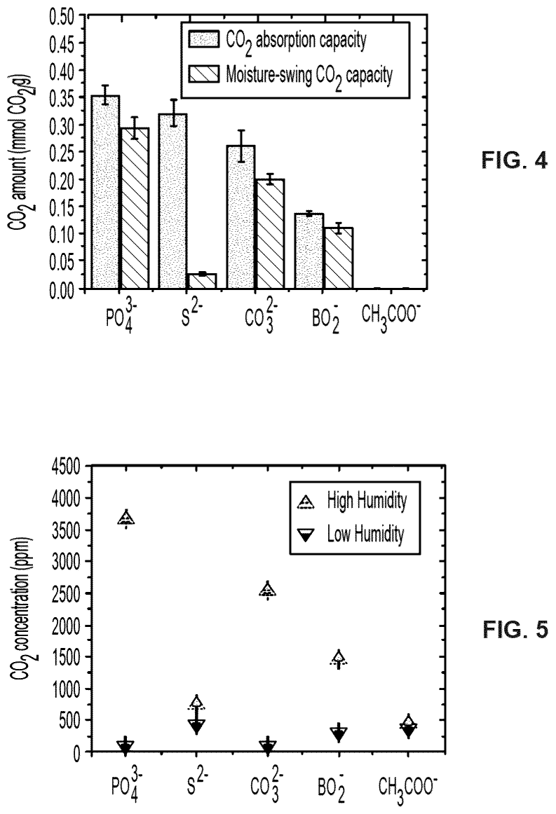

Carbon dioxide absorption capacity measurements may demonstrate the maximum quantity of carbon dioxide that can be captured by moisture-swing sorbent compositions under saturated conditions. Referring to FIG. 4, the carbon dioxide absorption capacity may vary substantially among different anion types loaded into ion exchange resin matrices, with values ranging from 0.14 to 0.35 millimoles of carbon dioxide per gram of sorbent material. Phosphate-loaded resins may exhibit the highest carbon dioxide absorption capacity at approximately 0.35 millimoles per gram, reflecting the high basicity of phosphate anions and their ability to generate substantial quantities of hydroxide anions through hydrolysis reactions. Sulfide-loaded resins may demonstrate carbon dioxide absorption capacities of approximately 0.32 millimoles per gram, indicating effective hydroxide generation despite the subsequent limitations in moisture-swing reversibility. Carbonate-loaded resins may achieve carbon dioxide absorption capacities of approximately 0.26 millimoles per gram, representing moderate performance that balances hydroxide generation with regeneration effectiveness. Borate-loaded resins may exhibit lower carbon dioxide absorption capacities of approximately 0.14 millimoles per gram, though this reduced capacity may be offset by enhanced absorption kinetics and improved moisture-swing reversibility.

The moisture-swing capacity measurements may represent the net carbon dioxide capture and release performance under alternating humidity conditions, providing a more realistic assessment of operational effectiveness compared to total absorption capacity measurements. The moisture-swing capacity may be calculated as the difference in carbon dioxide loading between low humidity capture conditions and high humidity regeneration conditions, reflecting the quantity of carbon dioxide that can be cycled through repeated moisture-swing operation. Moisture-swing capacities may range from 0.11 to 0.29 millimoles of carbon dioxide per gram of sorbent material, depending on the anion type and the effectiveness of the regeneration process under high humidity conditions. Phosphate-loaded resins may demonstrate the highest moisture-swing capacity at approximately 0.29 millimoles per gram, indicating effective carbon dioxide release during humidity-driven regeneration despite the high total absorption capacity. Carbonate-loaded resins may exhibit moisture-swing capacities of approximately 0.20 millimoles per gram, representing good reversibility characteristics that enable effective cycling between capture and regeneration phases.

Borate-loaded resins may achieve moisture-swing capacities of approximately 0.11 millimoles per gram, which may be close to their total carbon dioxide absorption capacity, indicating nearly complete reversibility during humidity-driven regeneration cycles. The high reversibility of borate-loaded systems may result from the moderate basicity of borate anions and their favorable interactions with water molecules during both hydrolysis and neutralization reactions. Sulfide-loaded resins may demonstrate limited moisture-swing capacity despite their high total absorption capacity, with moisture-swing values representing less than 10 percent of the total carbon dioxide capture capacity. The poor moisture-swing performance of sulfide-loaded resins may result from excessive water interactions that prevent effective neutralization reactions during the regeneration phase, leading to incomplete carbon dioxide release under high humidity conditions. The comparison between total absorption capacity and moisture-swing capacity may provide insights into the regeneration effectiveness of different anion types and their suitability for cyclic carbon dioxide capture applications.

Referring to FIG. 5, the carbon dioxide concentration measurements under high and low humidity conditions may demonstrate the environmental responsiveness of different anion types during moisture-swing operation. Under low humidity conditions, the carbon dioxide concentrations in the gas phase may remain at reduced levels as the sorbent materials capture carbon dioxide through hydroxide-mediated mechanisms. The effectiveness of carbon dioxide capture under low humidity conditions may vary among anion types, with phosphate, carbonate, and borate systems demonstrating substantial carbon dioxide removal from the gas stream. Under high humidity conditions, the carbon dioxide concentrations may increase significantly as the sorbent materials release captured carbon dioxide through neutralization reactions facilitated by elevated water activity. The magnitude of carbon dioxide release under high humidity conditions may indicate the regeneration effectiveness of each anion type, where larger concentration increases may correspond to more complete carbon dioxide recovery during the regeneration phase.

The carbon dioxide concentration data may reveal substantial differences in moisture-swing behavior among different anion types, with some systems demonstrating effective cycling between low and high carbon dioxide concentrations while others may exhibit limited responsiveness to humidity changes. Phosphate-loaded systems may achieve carbon dioxide concentrations exceeding 4000 parts per million during high humidity regeneration phases, indicating substantial carbon dioxide release from the saturated sorbent material. Carbonate and borate systems may demonstrate intermediate carbon dioxide concentrations during regeneration, reflecting moderate but effective carbon dioxide release under high humidity conditions. Sulfide-loaded systems may exhibit limited carbon dioxide concentration increases during high humidity exposure, confirming the poor regeneration characteristics observed in moisture-swing capacity measurements. The acetate-loaded systems may show minimal carbon dioxide concentration changes under both humidity conditions, consistent with the insufficient basicity of acetate anions for effective moisture-swing operation.

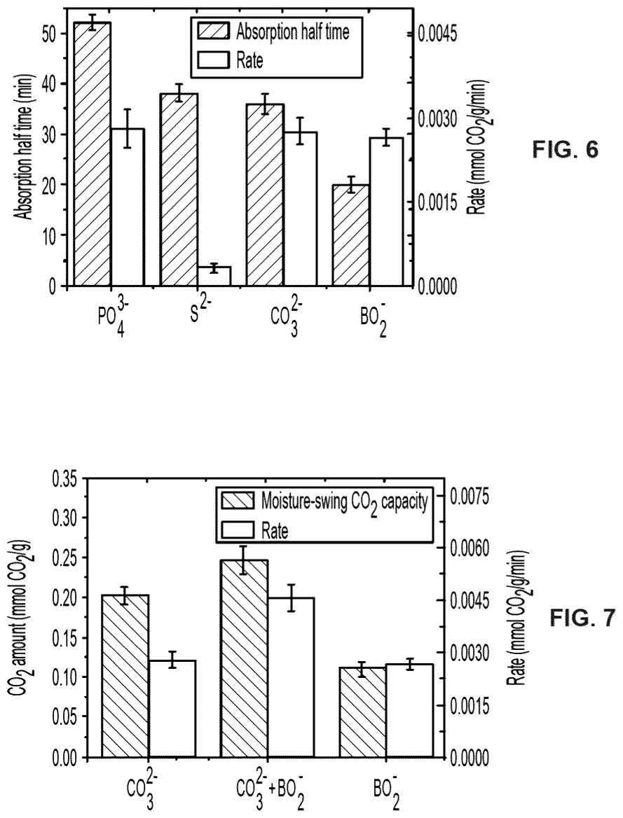

Absorption rate measurements may characterize the kinetics of carbon dioxide capture processes and may provide insights into the mass transfer limitations and reaction rates associated with different anion types and resin structures. Referring to FIG. 6, the absorption rates may vary among different anion-loaded systems, with values ranging from approximately 0.0027 to 0.003 millimoles of carbon dioxide per gram per minute for most effective anion types. Phosphate, carbonate, and borate systems may demonstrate similar absorption rates despite their different total capacities, suggesting that the kinetics of hydroxide generation and carbon dioxide capture may be influenced by factors beyond anion basicity alone. The absorption half-time measurements may provide complementary information about the time required to achieve 50 percent of the total absorption capacity, where shorter half-times may indicate faster approach to equilibrium conditions.

Phosphate-loaded systems may exhibit absorption half-times of approximately 50 minutes, indicating relatively slow approach to saturation despite the high total absorption capacity. The extended half-time for phosphate systems may result from mass transfer limitations within the resin matrix or from kinetic constraints associated with the hydrolysis reactions of phosphate anions. Carbonate and borate systems may demonstrate shorter absorption half-times of approximately 20-30 minutes, suggesting more rapid equilibration and potentially improved accessibility of anion sites within the resin structure. Sulfide-loaded systems may show notably lower absorption rates below 0.001 millimoles per gram per minute, indicating kinetic limitations that may contribute to the poor overall performance of sulfide-based moisture-swing sorbents. The absorption rate data may inform the design of moisture-swing systems where rapid response to changing environmental conditions may be desired, particularly for applications involving natural humidity cycling or batch processing operations.

The performance characteristics of mixed-anion systems may demonstrate synergistic effects that enhance both capacity and kinetic performance compared to single-anion configurations. Referring to FIG. 7, the mixed carbonate-borate system may achieve moisture-swing carbon dioxide capacity of approximately 0.25 millimoles per gram, which may exceed the individual performance of either carbonate-only or borate-only systems. The enhanced capacity of the mixed-anion system may result from complementary chemical mechanisms where carbonate and borate anions may contribute different reaction pathways for carbon dioxide capture and release. The mixed system may also demonstrate improved absorption rates of approximately 0.0045 millimoles per gram per minute, representing enhanced kinetics compared to the individual anion systems. The rate enhancement in mixed-anion systems may result from increased anion accessibility, improved water transport characteristics, or catalytic interactions between different anion types within the resin matrix.

The comparative performance data may indicate that the mixed carbonate-borate system may provide optimal balance between capacity, kinetics, and reversibility for moisture-swing carbon dioxide capture applications. The carbonate component may contribute established hydrolysis and neutralization pathways that provide reliable moisture-swing behavior, while the borate component may enhance absorption kinetics and potentially provide catalytic promotion of carbon dioxide capture reactions. The combination of both anion types within the same resin matrix may create diverse active site environments that can accommodate varying humidity conditions and carbon dioxide concentrations more effectively than single-anion systems. The mixed-anion approach may also provide improved stability over multiple moisture-swing cycles, where the different chemical properties of carbonate and borate species may contribute to maintained performance during repeated operation.

Water harvesting performance may represent an additional functionality of moisture-swing sorbent compositions that may provide value beyond carbon dioxide capture capabilities. The water absorption capacity may reach 0.1 grams of water per gram of sorbent material after 1 hour of exposure under 100 percent relative humidity conditions, demonstrating the hygroscopic nature of the loaded anions and their affinity for water molecules. The water harvesting functionality may result from the same hydration interactions that facilitate the moisture-swing mechanism, where anions within the resin matrix may attract and retain water molecules from humid air streams. The dual functionality may provide additional benefits for moisture-swing systems deployed in water-scarce regions, where atmospheric water harvesting may supplement local water supplies while contributing to carbon dioxide removal objectives. The water absorption process may occur simultaneously with carbon dioxide capture or may be optimized independently through adjustment of operational parameters and environmental conditions.

The water harvesting capacity may vary depending on the specific anion types loaded into the resin matrix and the structural characteristics of the ion exchange resin substrate. Anions with higher hydration numbers or stronger water interactions may demonstrate enhanced water absorption capabilities, though excessive water affinity may interfere with the regeneration process during moisture-swing cycling. The balance between water harvesting functionality and moisture-swing reversibility may require optimization of anion selection and loading densities to achieve effective dual-purpose operation. The water absorption kinetics may also influence the practical implementation of water harvesting functionality, where rapid water uptake may enable effective atmospheric water collection during periods of elevated humidity. The integration of water harvesting and carbon dioxide capture functionalities may provide economic advantages for moisture-swing systems by generating multiple value streams from a single sorbent material and processing infrastructure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 wt. %” is intended to mean “about 40 wt. %”.

### EXAMPLES

Anion Impacts on Moisture-Swing CO₂ Capture. Strongly basic ion-exchange resin materials containing quaternary amine groups and various counterions (i.e., anions) were investigated for moisture-swing direct air capture (FIGS. 1A-1B). CO₂ capture occurs through a two-step chemical reaction where water reacts with anions present in the absorbent material via hydrolysis to produce hydroxide anions (OH⁻) (see Step 1 in FIG. 1A). Next, the strongly basic hydroxide anions react with the incoming CO₂ gas from low-humidity air to produce bicarbonates (see Step 2 in FIG. 1A). CO₂ regeneration occurs at high humidity as water reacts with the bicarbonates and protonated anions and releases CO₂ (see Step 3, neutralization reaction, in FIG. 1B). Moisture-swing CO₂ capture mechanisms only occur with anions that are energetically prone to hydrolysis at low humidity and neutralization at high humidity.

Five anions with varying chemical and physical properties

$$( {CO}_{3}^{2 -} , {PO}_{4}^{3 -} , {S}^{2 -} , C {H}_{3} {COO}^{-} , and {BO}_{2}^{-} )$$

were evaluated as counterions for moisture-swing CO₂ capture and regeneration. The anions vary in terms of their basicity (phosphate (pKₐ=12.32)>sulfide (pKₐ=11.96)>carbonate (pKₐ=10.33)>borate (pKₐ=9.24)>acetate (pKₐ=4.76). Anion hydrolysis results in the formation of hydroxide anions. Hydroxide anions are the active site for CO₂ capture, and thus anions which undergo hydrolysis easily are more likely to achieve high capture capacity. In the CO₂ capture experiments, CO₂ can be absorbed by the sorbent material until it is saturated. After about 2.5 min, the absorbent becomes saturated, and the effluent CO₂ increases to the concentration in air (˜417 ppm) (see FIG. 2). FIG. 2 highlights a single pass experiment that can be used to evaluate capture capacity. The CO₂ absorption capacity is 0.26 mmol/g for

$${CO}_{3}^{2 -}$$

resin, 0.35 mmol/g for the

$${PO}_{4}^{3 -} .$$

-resin, 0.32 mmol/g for the S²⁻-resin, and 0.14 mmol/g for the BO₂⁻-resin. The acetate resin is incapable of CO₂ capture. The CO₂ absorption capacity increases with increasing anion basicity (see FIG. 4). The hydrolysis reaction can be represented as

$${A}^{-} \cdot {n H}_{2} O ↔ HA \cdot {x H}_{2} O + {OH}^{-} \cdot {y H}_{2} O + ( n - x - y - 1 ) {H}_{2} O \qquad ( 1 )$$

where A⁻ represents anions

$$( {CO}_{3}^{2 -} , {PO}_{4}^{3 -} , {S}^{2 -} , C {H}_{3} {COO}^{-} ) ,$$

and n, x, and y respectively represent the hydration numbers associated with the anion, the protonated anion, and the hydroxide.

During moisture-swing experiments, the CO₂ concentration swings between 93 ppm±11 ppm and 2530 ppm±40 ppm for the carbonate resin (see FIG. 3). Similarly,

$${PO}_{4}^{3 -}$$

-resin and BO₂⁻-resin exhibit moisture-swing behavior (see FIG. 5). The swing range of CO₂ concentrations can be further enhanced by increasing the amount of ion exchange resin in the experimental system. It should be noted that the moisture-swing CO₂ capture process produces a low partial pressure of released CO₂. Subsequent conversion or storage will require additional enrichment of the effluent stream. The moisture-swing CO₂ capacities (i.e., the difference in CO₂ loading between low and high humidity) are 0.29 mmol/g, 0.20 mmol/g, and 0.11 mmol/g for

$${PO}_{4}^{3 -}$$

-resin

$${CO}_{3}^{2 -}$$

-resin, and BO₂⁻-resin. These values are close to their total CO₂ absorption capacities (see FIG. 4). The sulfide-resin (S²⁻) can capture CO₂, but its moisture-swing CO₂ capacity is less than 10% of the total CO₂ capture capacity (see FIG. 4). Anions generate OH-active sites for the CO₂ capture. Thus, the accessible active sites determine the CO₂ capture capacity and rate. A higher capacity does not mean a higher capture rate. The phosphate-resin exhibits a higher moisture-swing CO₂ capacity (0.29 mmol/g) than the carbonate-resin (0.20 mmol/g), but the capture rates are similar (˜0.0028 mmol/g/min) (see FIG. 6). The BO₂⁻-resin exhibits a smaller capacity (0.11 mmol/g) and a slightly lower CO₂ absorption rate (0.0027 mmol/g/min) than that of the

$${CO}_{3}^{2 -}$$

-resin.

The protonated sulfide cannot react with bicarbonate and water to release absorbed CO₂ (see Step 3 in FIG. 1B). Prior theoretical work suggests that the reaction free energy of Equation 1 is negative for S²⁻ regardless of changes in the water activity. The resulting large quantity of OH⁻ hinders the neutralization reaction between bicarbonate and protonated sulfide. In contrast, prior modeling investigations have demonstrated that the reaction free energy of Equation 1 for

$${CO}_{3}^{2 -} and {PO}_{4}^{3 -}$$

depends on the local water activity. When the n in Equation 1 increases from 1 to 8, the reaction free energy will gradually change from negative to positive. Thus, protonated

$${CO}_{3}^{2 -} and {PO}_{4}^{3 -}$$

can react with bicarbonate to release CO₂ at high humidity. Interactions between the protonated anion and bicarbonate species are important for sorbent regeneration at high humidity. This example's results suggest that basicity is impactful for hydroxide formation and capture capacity. However, basicity is less impactful on the regeneration step. Instead, thermodynamic interactions between the protonated anion and bicarbonate are critical for regeneration of these sorbents. These dynamics are highlighted by sulfide's high basicity and limited moisture-swing capacity.

Mixed Anion Impact on Moisture-Swing CO₂ Capture. Ion-exchange resins with mixed anions

$$( {CO}_{3}^{2 -} and {BO}_{2}^{-} )$$

demonstrate an interesting CO₂ capture capacity and moisture-swing behavior. The mixed anion ion-exchange resin achieves a nearly 0.25 mmol/g±0.02 mmol/g capture capacity at a rate of 0.0045 mmol/g/min (see FIG. 7). There are two potential reaction pathways that can occur with a borate anion. First, hydrolysis of the borate anion can occur and result in hydroxide anions capable of CO₂ capture. Second, borate can catalytically promote CO₂ and water to react and directly form bicarbonate. The BO₂⁻-resin exhibited the highest hydration rate and lowest dehydration rate among all of the resins. Currently, it is unclear how ion-ion interactions and the potential for promotion of CO₂ impact water mobility. Nevertheless, this highlights how unique interactions between water, ions, and gases in chemical microenvironments are largely responsible for driving these mechanisms. Future experiments are necessary to fully unravel these effects.

Structural Impacts on Moisture-Swing Separation Mechanism. The confined region of the ion-exchange resin is composed of anions and pores. The resin pore structure influences reactant mobility and ion-water interactions (see FIG. 8). To study the role of the resin structure, two different resins were studied: AMBERCHROM™ 1×4 Ion Exchange Resin (Resin 1) and AMBERSEP® 900 Ion Exchange Resin (Resin 2). Resin 1 has a smaller particle size and a rough morphology, while Resin 2 has a larger diameter. Gas sorption experiments reveal that both resins demonstrate type III isotherms with H1 hysteresis. Resin 1 has a surface area of 267 m²/g and a pore radius of 3 nm. In comparison, Resin 2 has a surface area of 255 m²/g, and it contains both small pores with a radius of 3 nm and large pores with a radius in the range of 35 nm-135 nm.

Both resins underwent an ion-exchange process to replace the chloride anion will

$${CO}_{3}^{2 -}$$

anions. Resin 1 has a CO₂ capture capacity of 0.20 mmol/g and rate of 0.0028 mmol/g/min, while resin 2 has a capacity of 0.21 mmol/g and rate of 0.012 mmol/g/min. Thus, the two resins demonstrate similar CO₂ capture capacities but very different CO₂ absorption kinetics (see FIG. 9). X-ray pair-distribution function (PDF) analysis (see FIG. 10) reveals that both resins are highly amorphous. Both resins exhibited strong patterns at 1.45 Å and 2.47 Å (the characteristic C-C bond lengths for benzene rings and alkyl chains). A slight shift (0.1 Å) of the peak near 3.7 Å indicates a small local environment change for the quaternary amine group. The very similar local structure can be attributed to the similar micropore size of the two resins. The reaction free energy will be similar for resins with similar structural features (<2 Å). The two resins exhibited similar micropore sizes and local anion structures, and thus, the moisture-dependent hydrolysis reaction proceeded similarly in each sample. Therefore, it was concluded that micropores and shortrange order determine the extent of the anion hydrolysis reaction and control the moisture-swing CO₂ capacity.

The two resins exhibit different affinities for water. Resin 2 has a greater capacity for water and water uptake rate than Resin 1 (see FIG. 11). Resin 2 demonstrates a bimodal pore size distribution with a greater density of macropores when compared with Resin 1. It is known that active surface area is critical for moisture-swing CO₂ capture, and that intraparticle sorption facilitated by higher surface area plays a large role in CO₂ uptake kinetics. However, resins demonstrate hierarchical pore size distributions that encompass micropores, mesopores, and macropores. Resin 2 has a bimodal pore size distribution of equal density of micropores and macropores. Nano- and microstructural analyses of the two resins demonstrate that capture capacity is related to accessible surface area, and reactant transport and reaction rate are dictated by the presence of macropores. Engineering materials for high active sites (e.g., surface area) and reactant transport (pore size distribution) is critical for developing high performance moisture-swing CO₂ capture materials.

The reversibility of hydrolysis and neutralization at the active anion is critical for moisture-swing CO₂ capture. Also, the CO₂ absorption capacity increases with increasing anion basicity; highly basic anions can produce a greater density of hydroxide anions which serve as active sites for CO₂ capture. Finally, the results suggest that water-anion interactions within the confined region of the resin play a significant role in the reversibility of the regeneration process.

A number of implementations have been described. Nevertheless, it will be understood that various modifications may be made without departing from the spirit and scope of the disclosure. Accordingly, other implementations are within the scope of the following claims.

1. A moisture-swing sorbent composition, comprising:
an ion exchange resin loaded with a plurality of ions, the plurality of ions comprising a plurality of borate ions.

2. The moisture-swing sorbent composition of claim 1, wherein the plurality of ions consists of a plurality of carbonate ions and the plurality of borate ions.

3. The moisture-swing sorbent composition of claim 1, wherein the ion exchange resin has a surface area of less than 200 m²/g.

4. The moisture-swing sorbent composition of claim 1, wherein the ion exchange resin has a surface area of 200-300 m²/g.

5. The moisture-swing sorbent composition of claim 1, wherein the ion exchange resin has a surface area of more than 300 m²/g.

6. The moisture-swing sorbent composition of claim 1, wherein the ion exchange resin has a plurality of small pores having an average pore radius of less than 10 nm, and a plurality of large pores having an average pore radius of at least 25 nm.

7. The moisture-swing sorbent composition of claim 6, wherein the average pore radius of the plurality of small pores is 2 nm-4 nm, and the average pore radius of the plurality of large pores is 35 nm-135 nm.

8. A moisture-swing sorbent system, comprising:
a moisture-swing sorbent composition of claim 1; and
a housing having an inlet and outlet, the housing surrounding the moisture-swing sorbent composition, where the inlet is configured to receive a gas and direct the gas over or through the moisture-swing sorbent composition.

9. The moisture-swing sorbent system of claim 8, further comprising a processor configured to control the moisture-swing sorbent system such that a wet gas is passed over or through the moisture-swing sorbent composition when the moisture-swing sorbent composition is dry, and a dry gas is passed over or through the moisture-swing sorbent composition when the moisture-swing sorbent composition is wet.

10. The moisture-swing sorbent system of claim 9, further comprising a humidity control system, the humidity control system configured to prevent water condensation within the housing when a dew point in the gas is higher than room temperature.

11. The moisture-swing sorbent system of claim 8, wherein the gas is air.

12. The moisture-swing sorbent system of claim 8, wherein the gas is a gas other than air.

13. A method of manufacturing a moisture-swing sorbent composition, comprising:
mixing boric acid and sodium hydroxide in water to generate a basic solution of borate ions;
adding sodium carbonate to the basic solution of borate ions to create a carbonate-borate mixture;
mixing the carbonate-borate mixture with ion exchange resin particles to form intermediate particles in solution; and
forming the moisture-swing sorbent composition by filtering out the intermediate particles, washing the intermediate particles, and then drying the intermediate particles.
